(19) United States
(12) Patent Application Publication
(10) Pub. No.: US 2016/0003223 A1
(43) Pub. Date: Jan. 7, 2016

(54) ROTOR BLADE OF A WIND TURBINE

(71) Applicant: Eichenauer Heizelemente GmbH & Co. KG, Kandel (DE)

(72) Inventor: Manfred Barth, Weinheim (DE)

(73) Assignee: Eichenauer Heizelemente GmbH & Co. KG, Kandel (DE)

(21) Appl. No.: 14/770,623

(22) PCT Filed: Feb. 13, 2014
(86) PCT No.: PCT/EP2014/000399

§ 371 Date: Aug. 26, 2015

(30) Foreign Application Priority Data
Mar. 6, 2013 (DE) 10 2013 003 750.6

(51) Int. Cl. F03D 11/00; F03D 1/06

(52) U.S. Cl. CPC F03D 11/0025; F03D 1/0675

(57) ABSTRACT

The invention relates to a rotor blade for a wind turbine. The rotor blade includes at least one fan (3) for generating an airflow in the rotor blade and at least one heating device (6) for heating at least one part of the airflow. The heating device (6) has at least one heating module (15).

### BACKGROUND

The invention relates to a rotor blade for a wind power plant having at least one fan for generating an air flow in the rotor blade and at least one heating apparatus for heating at least part of the air flow.

The rotor blades of a wind power plant are essentially responsible for its degree of efficiency and are thus key components. For efficient power generation, wind power plants of this type are erected at locations with a high number of windy days and great wind speeds. Locations of this type are also found, in particular, in cold regions.

Here, ice formation occurs on the rotor blades in corresponding weather conditions. If ice formation occurs, the degree of efficiency of the wind power plant is reduced, since the aerodynamic profile of the rotor blades is reduced as a result of the ice formation. An unbalance of the rotor can also occur as a consequence of a formation of ice. Here, said reduction in the degree of efficiency takes place at a time with above average wind speeds, namely the fall and winter time.

In addition, ice chunks which fall down represent a danger. In the case of icing up of the rotor blades, therefore, wind power plants have to be brought to a standstill for safety reasons, in order to protect the surrounding area against pieces of ice which are flung off, what is known as ice shedding. Said standstill can last for several days up to weeks and signifies a considerable production downtime.

DE 196 21 485 A1 describes a rotor blade heater for wind power plants. Here, air inlet stubs are provided on a rotor blade flange. Warm air is generated by way of a heater and fan, which warm air is blown into the air inlet stub. The fan heater is situated outside the rotor blade.

EP 0 842 360 B1 describes a method for de-icing a rotor blade of a wind power plant, which rotor blade has cavities which communicate with one another. Here, a heated heat exchange medium is guided through the cavities. The means for introducing a heat exchange medium comprise an electric fan with an integrated heating element. The suction side of the fan is connected to the cavity, through which flow last passed; the pressure side of the fan is connected to the first cavity, with the result that a circuit is produced.

DE 10 2005 034 131 A1 describes a method and an apparatus for de-icing rotor blades of wind power plants. Here, heated air is guide through a channel from the blade root in the direction of the blade tip. The rotor blade de-icing system comprises a heating element which is arranged in the hub. The heating element is coupled to a fan or blower, in order to circulate the air which is heated by the heating elements.

### SUMMARY

It is an object of the invention to provide a rotor blade which is as inexpensive as possible for a wind power plant, in which a formation of ice is impeded and/or eliminated. This is to take place in as energy efficient a way as possible. A high flexibility is to be made possible here. The measures are preferably to be adaptable in a weather-specific manner, with the result that a targeted reaction can be effected both at temperatures around the freezing point and at very low temperatures. Furthermore, the rotor blades are to be relatively insusceptible to disruptions and easy to maintain.

According to the invention, this object is achieved by virtue of the fact that the heating apparatus has at least one heating module.

This modular construction makes high flexibility possible. For instance, the heating apparatus can be extended without problems for particularly cold regions by way of the use of a plurality of heating modules. In regions, in which low temperatures occur only rarely, a rotor blade having a heating apparatus with only one heating module can be used.

If a plurality of heating modules are used in the heating apparatus, they are preferably structurally identical. As a result, the heating apparatus can be extended in a simple and inexpensive way depending on the area of use of the rotor blade and the heating output of said heating apparatus which is required for this purpose.

In one particularly favorable embodiment of the invention, the rotor blade has a heating apparatus with at least two heating modules. The heating modules are preferably connected to a switching device, by way of which the modules can be switched on and/or off individually and/or in groups. The heating modules can also be connected, for example, in series and/or in parallel connection.

In one particularly advantageous embodiment of the invention, at least one module has at least two heating stages, with the result that the module can emit different heating outputs depending on the stage.

As a result, different weather conditions can be reacted to in a flexible and energy-efficient manner. Depending on the requirement, a different number of heating modules can be switched on or off. If there are particularly cold weather conditions, a large number of heating modules are switched on. If the weather conditions improve, only a small number of heating modules are switched on.

This switching on and off of the heating modules in groups produces a rotor blade, in which a formation of ice is avoided during the annual cycle in an extremely energy-saving way. In the fall and spring, a formation of ice can be avoided or ice can be removed by way of only a small number of modules being switched on with a low heat output. In winter, additional heating modules can be switched on, with the result that a freedom from ice of the rotor blades remains ensured even at low temperatures.

All the heating modules of a heating apparatus are preferably arranged in a common housing. In this way, a compact structural unit is produced which can be mounted easily and can be removed without problems in the case of maintenance work. The individual heating modules can be arranged within the compact structural unit either next to one another and/or above one another and/or behind one another.

Each heating module comprises at least one heating element. In the simplest case, the heating module therefore consists of the heating element itself. In one particularly favorable variant of the invention, each heating module comprises a plurality of heating elements.

In one particularly advantageous variant of the invention, heating elements are used in the rotor blade, which heating elements have at least one resistance heating conductor which is surrounded by a sheath. Rotor blades having heating elements of this type have considerable advantages. This is due, inter alia, to the fact that rotor blades are usually manufactured from glass fiber reinforced plastic (GRP) in a half shell sandwich construction. Materials such as PU foam or balsa wood for example are also frequently used. Carbon fiber reinforced plastic (CRP) is used in some rotor blades. Said materials are extremely sensitive to temperature peaks. At the same time, the air flow which is guided through the rotor blade has to be heated sufficiently, in order to prevent a formation of ice. In conventional rotor blades, high temperature peaks which represent a risk for the adjoining materials have occurred up to now in the region of the electric resistance heating conductors.

By way of the encapsulation, said risk is reduced considerably and homogeneous heat emission to the air flowing around it is ensured.

The sheaths are preferably hollow-cylindrical bodies, in which a resistance heating conductor is arranged, in particular axially centrally, what are known as sheath tubes. It proves particularly favorable here if the sheaths consist of a metal, preferably stainless steel, aluminum, copper or an alloy.

The sheath tubes level out temperature peaks and ensure a homogeneous temperature distribution. The heat is distributed within the sheath and is then emitted in a controlled manner from the sheath tube to the air which surrounds it, so that damage of the rotor blade as a result of temperature peaks is avoided. Here, the construction according to the invention at the same time makes a high throughput of warm air possible which reliably prevents a formation of ice.

In one particularly advantageous embodiment of the invention, the free space in the interior of the sheath tube is filled at least partially by an embedding compound. The resistance heating conductor is fixed in said embedding compound.

Tubular heating elements of this type prove particularly trouble-free and ensure high operational reliability. The embedding compound prevents the electric resistance heating element from coming into contact with the metallic sheath and it thus being possible for a short circuit to occur which might lead to a complete standstill of the wind power plant and therefore to high operating failures.

An embedding compound of magnesium oxide (MgO) has proven particularly favorable. This material is distinguished by a high thermal conductivity and very satisfactory electric insulating properties. Here, heat is generated in the rotor blade by way of the electric resistance heating conductors, which heat is guided homogeneously by the embedding compound to the metallic sheath tube and is then emitted homogeneously from the sheath to the air which flows past in the rotor blade. As a result, the rotor blades according to the invention can be supplied with a great heating output and can therefore be protected reliably against a formation of ice, without important construction components being endangered. Operating failures as a result of short circuits are virtually ruled out as a result.

A dedicated air guiding system is preferably arranged in the rotor blade for guiding the air flow. Rotor blades are usually manufactured in a sandwich design, webs which spatially divide the rotor blade in the interior running within the rotor blade. In conventional rotor blades, the heated air is guided through these cavities in the interior of the rotor blade. In one advantageous variant, in contrast, the construction according to the invention has a separate air guiding system which is arranged in the cavities. This air guiding system preferably consists of channels. As an alternative or in addition, the air guidance can also take place in tubes.

In one variant of the invention, the channels and/or tubes consist of a plastic or a composite material. Channels and/or tubes made from a thin and lightweight metal sheet can also be used.

The channels and/or tubes are preferably insulated at least in regions. In this way, the heated air can be guided first of all without heat losses to those locations of the rotor blade which are particularly susceptible to a formation of ice, without heat being lost on the way there. This is energy-efficient and lowers the operating costs.

It proves particularly favorable if the fan is arranged such that it is spaced apart from the heating apparatus. Here, in one preferred variant, at least one fan is arranged in the region of the blade root and/or the hub of the rotor. At least one heating apparatus is situated spaced apart spatially therefrom, preferably between the blade root and the blade tip.

In one particularly favorable variant, the air guiding system from the fan as far as the heating apparatus and/or from the heating apparatus as far as the blade tip of the rotor blade is formed by a closed channel and/or tube.

Here, insulation between the fan and the heating apparatus can advantageously be dispensed with.

The section of the air guiding system downstream of the heating apparatus is preferably insulated, with the result that only low heat losses occur, in particular in the air flow as far as the blade tip. In this way, the air still has a comparatively high temperature despite the long flow path as far as the blade tip.

The air guiding system preferably has at least one opening in the region of the blade tip.

In one variant of the invention, the return flow from the blade tip is also guided at least in regions in a channel and/or tube. It proves favorable here if the air guiding system also has openings at least in sections in this region.

The blade nose of the rotor blade is a further region which is susceptible to ice formation. Warm air flows out of the openings into the cavities of the rotor blade which adjoin the outer wall of the blade nose. In addition or as an alternative, the air return can also be guided in regions or completely within the cavities which are delimited by webs.

The heating apparatus is preferably arranged in a housing which has a cold air connector and/or a warm air connector. In this way, a compact structural unit is formed which can be integrated into the air guiding system of the rotor blade with low assembly outlay and can be dismantled and installed again rapidly in the case of repair work. Here, the connectors are adapted to the dimensions of the air guiding channels or tubes. In one variant of the invention, a plug-in connection is used between the connectors of the housing and the channels and/or tubes. The housing is preferably hermetically closed.

It proves advantageous if the heating apparatus is arranged in the rotor blade such that it is spaced apart from the fan, in particular between the blade root and the blade tip. It has proven particularly advantageous here to arrange the heating apparatus at the centroid of the rotor blade. Since the rotor blade becomes thinner and thinner toward the outside, the center of gravity usually does not lie in the geometric center, but rather displaced toward the blade root. This arrangement at the centroid of the rotor blade yields considerable advantages. For instance, powerful and therefore comparatively heavy heating apparatuses can also be used, without the degree of efficiency or the stability of the rotor blade being influenced negatively.

The method according to the invention for de-icing a rotor blade of a wind power plant has the following steps:
generation of an air flow in the rotor blade,
heating of the air flow by means of a heating apparatus.

According to the invention, said heating apparatus has modules which can be switched on and/or switched off separately.

In one particularly favorable variant of the method, the air is heated with a high power output during a first phase. The heating is reduced during a second phase. This preferably takes place in a step-like manner. It proves particularly favorable here if the reduction of the heating takes place by way of switching off of the individual heating modules. Here, a device for control and/or regulation is preferably used, which device is set up to switch off different heating modules in an alternating manner, with the result that the same heating modules are not always switched off. Homogeneous utilization of the heating modules is thus achieved and their service life is extended.

As an alternative to switching off or on of heating modules, the device for control and/or regulation can also decrease or increase the power output of the individual modules. This preferably takes place by means of power controllers which continuously regulate the electrical power.

The air flow runs at least partially in a closed air guiding system which is arranged in the cavities of the rotor blade. In one variant of the invention, the air guiding system has openings at least in regions.

The air guiding can take place in different ways.

In one variant of the invention, the heating apparatus is arranged in a region which is immediately adjacent to the blade nose and runs virtually parallel to the blade nose. Said region is called a front region in the following text, since it runs immediately adjacently to the front edge of the rotor blade.

Here, the air is conveyed by a fan to the heating apparatus, it proving particularly favorable if the air is guided in a closed channel and/or tube between the fan and the heating apparatus.

Downstream of the heating apparatus, a further channel section and/or tube section is then connected to the heating apparatus, through which channel section and/or tube section the heated air flows out in the direction of the blade tip. Said section is preferably not guided as far as the blade tip, but rather imparts only the desired direction to the heated air. Here, this can be a jet tube. In said variant, the return of the air preferably takes place in a central region which is arranged between the blade nose and the rotor blade rear edge and runs virtually parallel to the blade nose or rotor blade rear edge. Here, this is preferably a center channel. In one variant of the invention, the return flow in said central region is limited only by webs of the rotor blade, with the result that no closed channels and/or tubes are arranged in this region.

In one alternative embodiment of the invention, the heating apparatus is in a central region of the rotor blade which is arranged between the blade nose and the rotor blade rear edge and runs virtually parallel to the blade nose or rotor blade rear edge. The air is conveyed by the fan to the heating apparatus in a closed channel and/or tube. From the heating apparatus toward the blade tip, it likewise proves favorable if a channel or tube section is arranged on the heating apparatus, through which channel or tube section the air flows out toward the blade tip. Here, this is preferably a jet tube.

In one particularly favorable embodiment of the invention, at least one reserve fan is used which stands in in the case of a failure of the main fan and discharges the heat of the heating apparatus. This is of central significance, in particular, in the case of the rotor blades having tubular heating elements. According to the invention, the tubular heating elements ensure rapid and reliable de-icing.

Since, due to their high thermal capacity, tubular heating elements have still stored a large residual amount even after switching off, at least one auxiliary fan is provided which is switched on in the case of a failure of the main fan. If said reserve fan were not present, it might not be sufficient to simply switch off the tubular heating elements in the case of a failure of the main fan. The emergency fan serves as a safeguard against overheating. The emergency fan preferably has a smaller power output than the main fan.

Temperature sensors which are connected to a device for control and/or regulation are preferably arranged in the rotor blade. If predefined temperature limit values are exceeded, the device can switch off heating modules or switch on a reserve fan and/or increase the delivery capacity of the main fan.

In one particularly favorable embodiment of the invention, the housing which surrounds the heating apparatus has an insulation. The insulation protects the rotor blade in the region of the heating module against overheating and prevents the undesired heat emission in this region. This is also advantageous, in particular, in the case of a failure of a fan, since a high residual heat is stored in the case of the rotor blades according to the invention with tubular heating elements.

The rotor blades according to the invention have the advantage that the heating apparatuses can be retrofitted or replaced in a simple way, without it being necessary for relatively great structural measures to be taken. Under this aspect, the variant is preferred, in which the heated air is guided in the front region without a channel or tube section as far as the blade tip, since this facilitates retrofit installation.

### BRIEF DESCRIPTION OF THE DRAWINGS

Further advantages and features of the invention result from the description of one exemplary embodiment using drawings, and from the drawings themselves, in which:

FIG. 1 shows a diagrammatic longitudinal section of a rotor blade,

FIG. 2 shows a diagrammatic longitudinal section of a heating apparatus,

FIG. 3 shows a diagrammatic longitudinal section of a heating element, and

FIG. 4 shows a perspective illustration of a heating apparatus.

### DETAILED DESCRIPTION OF THE PREFERRED EMBODIMENTS

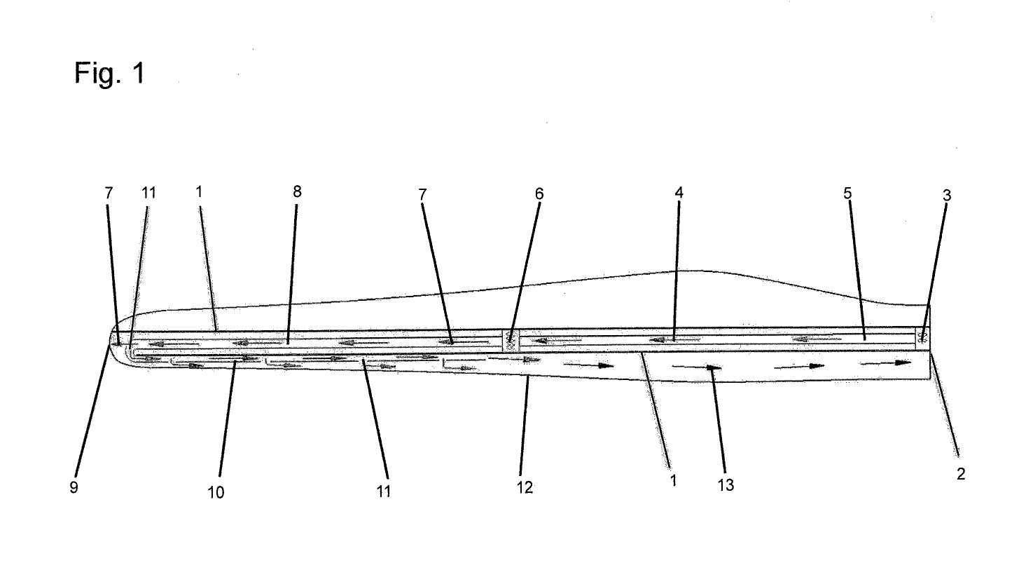

FIG. 1 shows a rotor blade of a wind power plant. In the exemplary embodiment, it is a rotor blade made from glass fiber reinforced plastic which is manufactured in a half shell sandwich design.

The wind power plant comprises a tower with a nacelle. The generator and preferably a gear mechanism are arranged in the nacelle. The nacelle is mounted rotatably on the tower. The rotor of the wind power plant comprises a hub and the rotor blades.

The length of the rotor blades preferably lies between 30 and 65 m.

Webs 1 run in the interior of the rotor blade. The webs 1 divide the interior of the rotor blade.

A fan 3 is arranged in the blade root 2 of the rotor blade. The fan 3 conveys a cold air flow 4. An air guiding system is arranged in the cavities of the rotor blade. The first section 5 extends from the fan 3 as far as a heating apparatus 6. The first section 5 of the air guiding system consists of a closed channel. As an alternative, a closed tube can also be used for guiding the cold air flow 4 to the heating apparatus 6. In the exemplary embodiment, the first section 5 of the air guiding system is manufactured from plastic.

The heating apparatus 6 is arranged such that it is spaced apart spatially from the fan 3. The fan 3 and the heating apparatus 6 are connected to a closed channel. In the exemplary embodiment, a particularly favorable variant of the invention is shown, in which the heating apparatus 6 is arranged at the centroid of the rotor blade.

The heating apparatus 6 heats the air flow and the warm air flow 7 is guided in a second section of the air guiding system 8 to the blade tip 9. The second section 8 of the air guiding system is likewise a plastic channel which is closed in an airtight manner in the exemplary embodiment. In addition, said second section 8 of the air guiding system is insulated to the outside in the exemplary embodiment or consists of poorly conducting plastic, with the result that low heat losses occur.

The warm air flows 7 passes through at least one opening 11 and strikes the inner wall of the blade tip 9 and heats the latter. A formation of ice on the blade tip is impeded or eliminated as a result.

The air flow is guided back in the direction of the blade root 2 in a third section 10 of the air guiding system. The third section 10 of the air guiding system is a channel which has further openings 11. Warm air flows through the openings 11 onto the inner walls of the blade nose 12. Since the rotor blade is flowed around from the nose edge, the icing of a rotor blade preferably starts at the blade nose 12. This formation of ice is impeded by the warm air flow which is guided onto the inner wall in the region of the blade nose edge.

The fourth section 13 is formed by a cavity of the rotor blade which is delimited by webs 1 and the inner walls. No channel is arranged in said fourth region 13 of the air guiding system. The air flows back to the blade root 2.

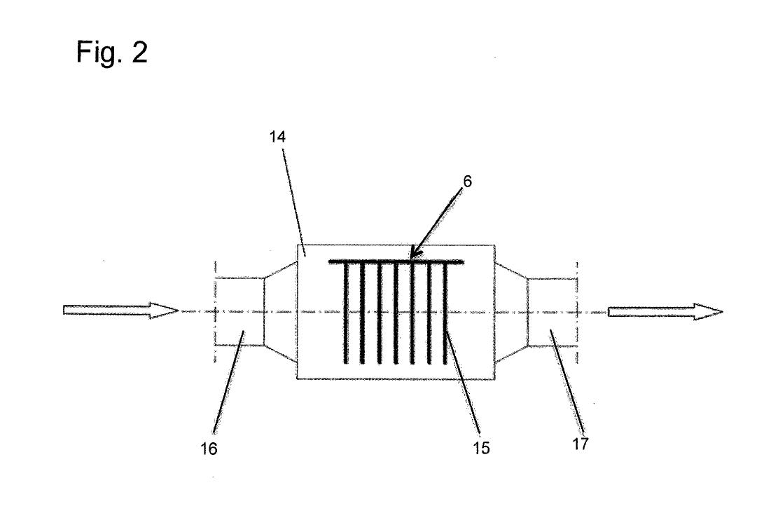

FIG. 2 shows a diagrammatic cross section of the heating apparatus 6 which is surrounded by a housing 14. The heating apparatus 6 comprises a plurality of heating modules 15 in the exemplary embodiment. Seven heating modules 15 are shown by way of example in the drawing. The heating modules 15 can be switched on and/or switched off in groups. As a result, different weather conditions can be reacted to in a flexible manner. In the exemplary embodiment, each heating module 15 comprises a heating element. As an alternative, a heating module 15 can also comprise a plurality of heating elements.

The heating apparatus 6 is surrounded by a hermetically closed housing 14 which has a cold air connector 16 and a warm air connector 17. In the exemplary embodiment, both the cold air connector 16 and the warm air connector 17 are connected to a channel.

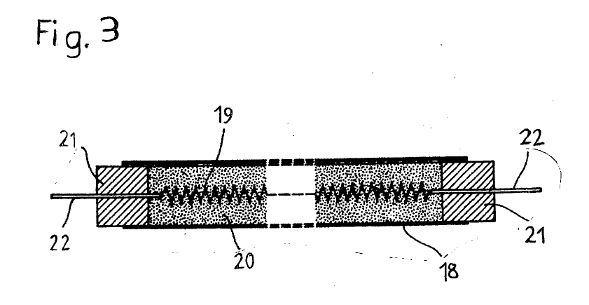

FIG. 3 shows a diagrammatic longitudinal section of the heating element. In the exemplary embodiment, the rotor blade according to the invention comprises heating elements which have a metallic sheath tube 18. A resistance heating element 19 is arranged in the center of the sheath tube 18. The free space of the sheath tube 18 is filled by an embedding compound 20. At its ends, the sheath tube 18 is closed by way of plug-shaped closure parts 21 which are secured against displacement. Pin-shaped connector elements 22 are guided through the closure parts 21, which connector elements 22 are connected to the resistance heating element 19 and make it possible to connect the latter to an electrical power source. An embedding compound 20 which comprises magnesium oxide (MgO) is used in the exemplary embodiment.

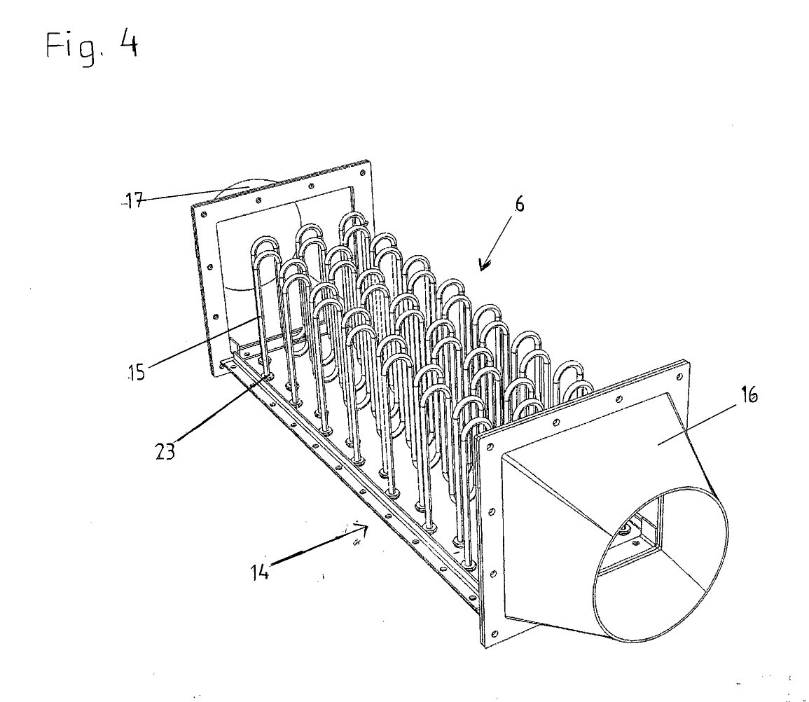

FIG. 4 shows a perspective illustration of a heating apparatus 6 which is surrounded by a housing 14. In the exemplary embodiment, the heating apparatus 6 comprises a plurality of heating modules 15 which can be switched on and/or switched off individually or in groups. The heating modules 15 are configured as tubular heating elements which are arranged offset with respect to one another in the throughflow direction in the exemplary embodiment. The heating modules 15 are arranged on a wall and protrude into a space which is enclosed by the housing 14. The wall is formed by the housing 14. Three side walls of the housing 14 are not shown in the drawing, in order that a view is allowed into the interior of the heating apparatus 6.

Tubular heating elements are arranged behind one another in a plurality of rows in the throughflow direction. They are preferably arranged offset with respect to one another in the throughflow direction. The heating modules 15 which are configured as tubular heating elements have a plurality of windings. In the exemplary embodiment, a tubular heating element which meanders in an undulating manner is arranged in each row. As a result of the undulating form of the tubular heating elements, loops are formed which protrude into the space. Each heating module 15 has fastening points 23 on two longitudinal sides of a wall of the housing 14 which lie opposite one another. The individual heating modules 15 are fixed via the fastening points 23 on a surface which is formed by a side wall of the housing 14. In the exemplary embodiment, all the heating modules 15 are fastened to the same surface of the heating apparatus 6. The electrical connectors for the heating modules 15 are arranged behind said surface, outside the flow space.

The heating apparatus 6 is surrounded by a hermetically closed housing 14 which is configured in a box-shaped manner as a cuboid with four side walls and has a cold air connector 16 on one end side and a warm air connector 17 on another end side.

In the exemplary embodiment, both the cold air connector 16 and the warm air connector 17 have a shape which tapers toward the connector tubes or channels. The radial dimensions of the heating apparatus 6 are greater than those of the connecting tubes or channels.

1. A rotor blade for a wind power plant comprising at least one fan that generates an air flow in the rotor blade and at least one heating apparatus that heats at least part of the air flow, and the heating apparatus includes at least one heating module.

2. The rotor blade as claimed in claim 1, wherein the at least one heating module comprises two of the modules that are connected to a switching device, for switching the heating modules at least one of on and/or off individually or in groups.

3. The rotor blade as claimed in claim 1, wherein the heating module comprises at least one heating element.

4. The rotor blade as claimed in claim 3, wherein the heating element has at least one resistance heating conductor which is surrounded by a sheath.

5. The rotor blade as claimed in claim 4, wherein an embedding compound at least partially fills a free space in an interior of the sheath.

6. The rotor blade as claimed in claim 1, wherein an air guiding system is arranged in the rotor blade that at least partial guides the air flow.

7. The rotor blade as claimed in claim 6, wherein at least one section of the air guiding system is formed by a closed channel or closed tube.

8. The rotor blade as claimed in claim 6, wherein at least one section of the air guiding system has openings.

9. The rotor blade as claimed in claim 1, wherein the heating apparatus is arranged in a housing which has a cold air connector, a warm air connector, or both of the connectors.

10. The rotor blade as claimed in claim 9, wherein at least one of a channel or tube is connected to the cold air connector or to the warm air connector.

11. The rotor blade as claimed in claim 1, wherein the heating apparatus is arranged in the rotor blade spaced apart from the at least one fan.

12. The rotor blade as claimed in claim 1, wherein the heating apparatus is arranged in a region of a centroid of the rotor blade.

13. A method for de-icing the rotor blade of a wind power plant, having the rotor blade as claimed in claim 1, comprising the following steps:
generating an air flow in the rotor blade,
heating at least part of the air flow with the heating apparatus, the heating apparatus comprising heating modules and at least one of switching on or switching off the heating modules individually or in groups.
